(19) United States
(12) Patent Application Publication
(10) Pub. No.: US 2015/0288776 A1
(43) Pub. Date: Oct. 8, 2015

(54) Pushing Messages for Web Applications

(71) Applicant: TENCENT TECHNOLOGY (SHENZHEN) COMPANY LIMITED, Shenzhen (CN)

(72) Inventors: Jiangquan Huang, Shenzhen (CN); Lei Chen, Shenzhen (CN); Liang Zeng, Shenzhen (CN); Ming He, Shenzhen (CN); Shudong Ruan, Shenzhen (CN); Shuning Tian, Shenzhen (CN); Ping Chen, Shenzhen (CN); Wenwen Wu, Shenzhen (CN)

(21) Appl. No.: 14/744,251

(22) Filed: Jun. 19, 2015

Related U.S. Application Data
(63) Continuation of application No. PCT/CN2013/090614, filed on Dec. 27, 2013.

(30) Foreign Application Priority Data
Dec. 28, 2012 (CN) 201210586394.4

(51) Int. Cl. H04L 29/08

(52) U.S. Cl. CPC H04L 67/26

(57) ABSTRACT

Various examples provide a method, a browser and a system of pushing messages for web applications. According to the method, a web application component is provided in a browser, the web application component corresponding to a web application; the browser obtains a push message corresponding to the web application from a background server and provides the push message for the web application component; the web application component presents information of the push message in a user interface of the browser.

### RELATED DOCUMENTS

The present disclosure claims priority of Chinese patent application No. 201210586394.4 titled “method, apparatus and system of pushing messages for web applications” and filed on Dec. 28, 2012 with the Patent Office of the People's Republic of China, the disclosure of which is incorporated by reference in its entirety.

### TECHNICAL FIELD

The present disclosure relates to web applications, and particularly to pushing messages for web applications.

### BACKGROUND

“Push” of messages, which means web broadcasting, refers to a technique of delivering information to users through the Internet at intervals according to a certain technical standard or protocol to prevent information overload. Based on multiple categories of techniques such as data mining, natural language processing and Internet technology, the “push” technique searches for and filters information according to interest of a user and actively pushes latest news and information to the user at intervals, so that the user does not have to search online by him/herself.

A web application (or web-based application) is any application that uses a web browser (also simply referred to as a browser) as a client, or a computer software application that is coded in a browser-supported programming language (such as JavaScript, combined with a browser-rendered markup language like HTML) and reliant on a common web browser to render the application executable. Web applications are popular due to the ubiquity of web browsers, and the convenience of using a web browser as a client. The ability to update and maintain web applications without distributing and installing software on potentially thousands of client computers is a key reason for their popularity, as is the inherent support for cross-platform compatibility.

### SUMMARY

Examples of the present disclosure provide a method, an apparatus and a system of pushing messages for web applications to automatically send latest messages for web applications to user terminal devices for display.

According to an example, a method of pushing messages for web applications may include:
providing a web application component in a browser, the web application component corresponding to a web application;
obtaining, by the browser, a push message corresponding to the web application from a background server, and providing the push message for the web application component;
presenting, by the web application component, information of the push message in a user interface of the browser.

According to an example, an apparatus of pushing messages for web applications may include a processor and a memory; the memory stores a browser which may include:
a message pulling module, adapted to obtain a push message corresponding to a web application from a background server;
an information center, adapted to provide the push message obtained by the message pulling module for the web application component;
the web application component, adapted to present information of the push message in a user interface of the browser.

According to an example, a system of pushing messages for web applications may include a browser and a background server. The browser may include:
a message pulling module, adapted to obtain a push message corresponding to a web application from the background server;
an information center, adapted to provide the push message obtained by the message pulling module for a web application component corresponding to the web application;
the web application component, adapted to present information of the push message in a user interface of the browser.

According to an example of the present disclosure, a non-transitory computer-readable storage medium may include a set of instructions for pushing messages for web applications. The set of instructions may cause at least one process to perform the acts of:
providing a display element in a user interface of a browser, the display element corresponding to a web application;
obtaining a push message corresponding to the web application from a background server; and
displaying information of the push message via the display element in the user interface of the browser.

In view of the above examples, the browser may send a push message for a web application obtained from the background server to the web application component which presents information of the message in the user interface of the browser. Since latest messages for web applications can be presented in the user interface of the browser, messages for web applications can be easily pushed to users of terminal devices according to the technical mechanism to implement functions such as update alert and service operations and etc., which can improve user satisfaction and increase user retention.

### BRIEF DESCRIPTION OF THE DRAWINGS

Features of the present disclosure are illustrated by way of example and not limited in the following figures, in which like numerals indicate like elements, in which:

FIG. 1 is a schematic diagram illustrating a communication system;

FIG. 2 is a schematic diagram illustrating an example of a computing device;

FIG. 3 is a flowchart illustrating a method of pushing messages for web applications in accordance with an example of the present disclosure;

FIG. 4 is a flowchart illustrating a method of pushing messages for web applications in accordance with an example of the present disclosure;

FIG. 5 is a flowchart illustrating a method of pushing messages for web applications in accordance with an example of the present disclosure;

FIG. 6 is a schematic diagram illustrating modules of an apparatus of pushing messages for web applications in accordance with an example of the present disclosure;

FIG. 7 is a schematic diagram illustrating modules of an apparatus of pushing messages for web applications in accordance with an example of the present disclosure;

FIG. 8 is a schematic diagram illustrating modules of an apparatus of pushing messages for web applications in accordance with an example of the present disclosure;

FIG. 9-a is a schematic diagram illustrating modules of an apparatus of pushing messages for web applications in accordance with an example of the present disclosure;

FIG. 9-b is a schematic diagram illustrating modules of an apparatus of pushing messages for web applications in accordance with an example of the present disclosure;

FIG. 10-a is a schematic diagram illustrating modules of an apparatus of pushing messages for web applications in accordance with an example of the present disclosure;

FIG. 10-b is a schematic diagram illustrating modules of an apparatus of pushing messages for web applications in accordance with an example of the present disclosure;

FIG. 10-c is a schematic diagram illustrating modules of an apparatus of pushing messages for web applications in accordance with an example of the present disclosure;

FIG. 10-d is a schematic diagram illustrating modules of an apparatus of pushing messages for web applications in accordance with an example of the present disclosure;

FIG. 11 is a schematic diagram illustrating modules of an apparatus of pushing messages for web applications in accordance with an example of the present disclosure;

FIG. 12 is a schematic diagram illustrating modules of an apparatus of pushing messages for web applications in accordance with an example of the present disclosure;

FIG. 13 is a schematic diagram illustrating modules of a system of pushing messages for web applications in accordance with an example of the present disclosure.

### DETAILED DESCRIPTIONS

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. Quantities of an element, unless specifically mentioned, may be one or a plurality of, or at least one.

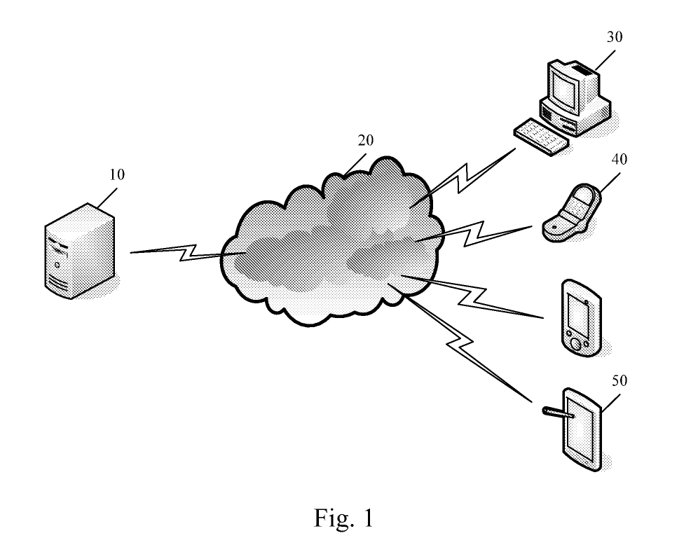

FIG. 1 is a schematic diagram illustrating a communication system; As shown in FIG. 1, the communication system includes a server 10, a communication network 20 and user terminal devices. A user terminal device may be a personal computer (PC) 30, a mobile phone 40, a tablet computer 50, or other types of mobile Internet devices (MID), such as an electronic book reader, a handheld game console and etc. that can access the Internet using a certain wireless communication technology.

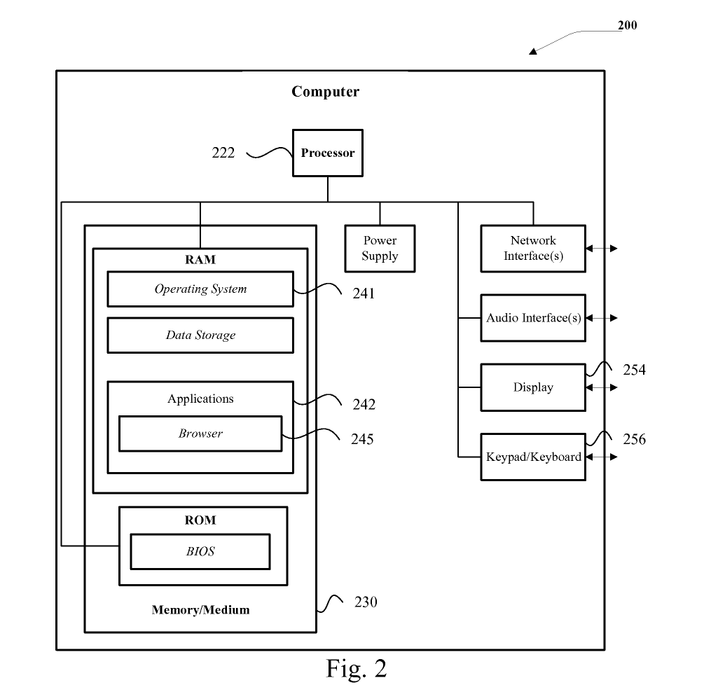

In an example, the user terminal device may be a computing device that may execute methods and software systems of various examples of the present disclosure. FIG. 2 is a schematic diagram illustrating an example of a computing device. As shown in FIG. 2, computing device 200 may be capable of executing a method and apparatus of the present disclosure. The computing device 200 may, for example, be a device such as a personal desktop computer or a portable device, such as a laptop computer, a tablet computer, a cellular telephone, or a smart phone. The computing device 200 may also be a server that connects to the above devices locally or via a network.

The computing device 200 may vary in terms of capabilities or features. Claimed subject matter is intended to cover a wide range of potential variations. For example, the computing device 200 may include a keypad/keyboard 256. It may also comprise a display 254, such as a liquid crystal display (LCD), or a display with a high degree of functionality, such as a touch-sensitive color 2D or 3D display. In contrast, however, as another example, a web-enabled computing device 200 may include one or more physical or virtual keyboards, and mass storage medium 230.

The computing device 200 may also include or may execute a variety of operating systems 241, including an operating system, such as a Windows™ or Linux™, or a mobile operating system, such as iOS™, Android™, or Windows Mobile™. The computing device 200 may include or may execute a variety of possible applications 242, such as a web browser 245. The web browser 245 may render and execute web applications.

Further, the computing device 200 may include one or more non-transitory processor-readable storage medium 230 and one or multiple processors 222 in communication with the non-transitory processor-readable storage medium 230. For example, the non-transitory processor-readable storage medium 230 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage medium 230 may store sets of instructions, or units and/or modules that comprise the sets of instructions, for conducting operations described in the present application. The one or multiple processors may be configured to execute the sets of instructions and perform the operations in examples of the present application.

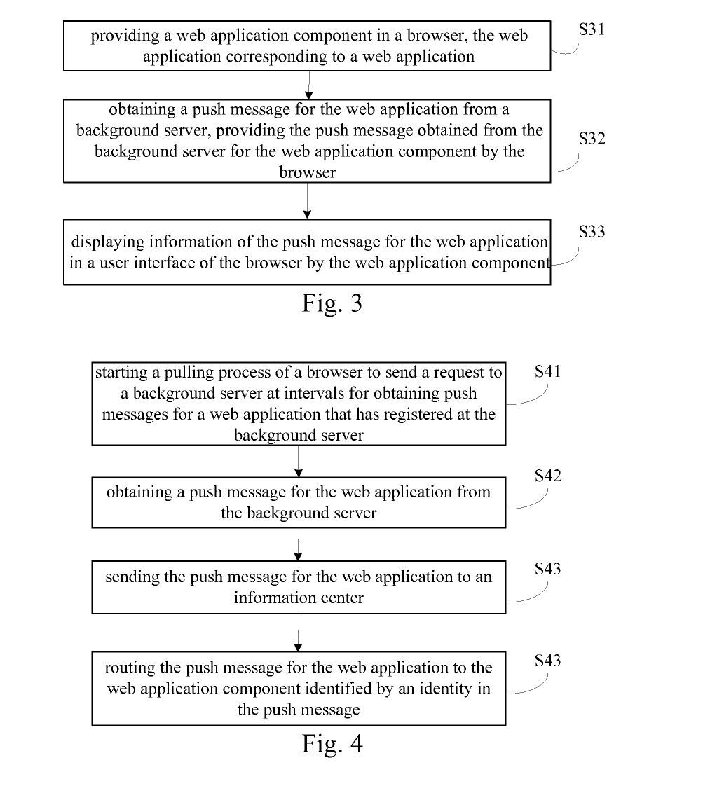

FIG. 3 is a flowchart illustrating a method of pushing messages for web applications in accordance with an example of the present disclosure. The method may be executed by various user terminal devices as shown in FIG. 1, e.g., may be implemented by a browser in a smart phone. The method may include the following procedures.

At block S31, a web application component is provided in a browser. The web application component is corresponding to a web application.

There may be one or multiple web application components in the browser. The web application component is merely taken as an example for simplifying description. Each web application component may include a processing component and a display component. The processing component may be implemented by a code segment in the browser. The display component may be a display element in a user interface of the browser, e.g., an icon, a text, a button and the like. In the following, the processing component and the display component may not be specifically identified, and may be mentioned in general as the web application component.

Each web application component is corresponding to a web application which may be configured by a provider of the browser or by a user of the browser. The user may input a command via a user interface into the browser, and the browser may add or delete a web application component corresponding to a web application according to the command. In an example, the browser may provide a list of available web applications to the user, and adds a pre-defined web application component corresponding to a web application selected by the user into a component list of the browser. Each time the browser starts up, the browser may call program codes corresponding to web application components in the component list to display the components in the user interface of the browser. Program codes corresponding to a web application component may be provided by the provider of the browser or by the provider of the web application.

In an example, an area in the user interface of the browser (also referred to as browser client) may be designated as an area for displaying information of web application, i.e., web application components are displayed in the area.

In an example, a display element, e.g., an icon, corresponding to a web application component not only serves as an entrance to the web application, but also displays information of push messages. The icon may also display contents provided by a web application in a dynamic manner, e.g., displaying current weather situation when the web application is a weather application. The user may visit the web application by clicking the display element corresponding to the web application.

At block S32, the browser obtains a push message for a web application from a background server of the browser (which is simply referred to as background server in the following), and provides the push message obtained from the background server for the web application component corresponding to the web application.

A push message for a web application to which the web application component correspond is also simply referred to as a push message for the web application component.

The background server may obtain the push message from a network device of a provider of the web application (e.g., a server of the web application). The background server may obtain push messages in real time or store push messages obtained previously from the server of the web application, and provide the push messages to browsers.

At block S33, the web application component presents information of the push message in a user interface of the browser.

The information of the push message presented may be the number of push messages, a status of the web application and so on, or may be a part or all of content of the push message. The web application component may present the information via the display element in the user interface of the browser, e.g., on top of an icon corresponding to the web application component on the user interface of the browser, or present the information through changing the icon displayed, or present the information in a bubble or a floating window or a popup window or the like.

The user may click on the icon to visit the web application. The web application component may trigger the browser to display a page of the web application, and the web application displays contents of the push message in the page.

FIG. 4 is a flowchart illustrating a method of pushing messages for web applications in accordance with an example of the present disclosure. The method may be executed by various user terminal devices as shown in FIG. 1, and may be implemented by an application in a storage medium in the terminal device, e.g., a browser in the memory of a smart phone. The method may include the following procedures.

At block S41, a pulling process of a browser is started up which sends a request to a background server of the browser for obtaining push messages for a web application that has registered at the background server.

In an example, a timer module may be set up in the browser. When the timer expires, the pulling process of the browser (simply referred to as pulling process) is started up and sends a request to the background server. The request is for requesting the background server to provide push messages for a web application that has registered at the background server. If there is a new push message for the web application, the background server pushes the new push message to the pulling process of the browser according to the request. The pulling process receives the push message returned by the background server in response to the request. The push message may include an identity identifying the web application.

At block S42, a push message for the web application is obtained from the background server. The push message may include an identity identifying the web application.

At block S43, the push message for the web application is sent to an information center in the browser.

The push message for the web application returned by the background server may be obtained by the browser as a data packet. Therefore, the browser may parse the data packet after receiving the data packet from the background server to obtain the push message. Then the browser may send the push message to the information center.

At block S44, the information center routes the push message for the web application to a web application component identified by the identity in the browser.

In an example, the information center is a functional module in the browser, and is capable of routing push messages for web applications to web application components corresponding to the web applications. Since the identity is a unique identification of a web application, the information center may route the push message for the web application to the web application component corresponding to the web application according to the identity. The routing process refers to the process of the information center providing the push message to the web application component corresponding to the web application identified by the identity so that program codes corresponding to the web application component may process the push message according to a pre-defined rule.

As such, the information center routes push messages for web applications obtained at intervals from the background server to web application components by using identities which identify web applications so that the push messages are displayed via display elements, e.g., icons, corresponding to the web applications in the user interface of the browser. Since latest messages for web applications can be presented in the user interface of the browser, messages for web applications can be easily pushed to users of terminal devices according to the technical scheme to implement functions such as update alert and service operations, which can improve user satisfaction and increase user retention.

In an example, the information center may store push messages in a local database of the browser, and record information of the push messages. The recorded information of a push message (simply referred to as a record in the following) may represent whether prompt information for the push message has been displayed, or whether contents of the push message have been displayed and the like. For example, a value of a record may indicate a push message: not prompted, prompted, not displayed, or displayed, and so on. The information center may also delete a record corresponding to a push message for a web application stored in the local database, or search the local database for push messages corresponding to a web application. In an example, the push messages may be stored in the local database of the browser in a specified format, i.e., push messages may be stored after being received. When the user clicks on the web application component displayed on the user interface of the browser or places a cursor over the web application component to have a push message for the web application displayed, the push message may be deleted from the local database after being displayed. When the push message is deleted, the record corresponding to the push message is also deleted from the local database. After startup, the browser may search in the local database for all of push messages for a web application that have not been deleted, and make the web application component corresponding to the web application display the push messages. In an example, after a web application component is clicked on again, a page of the web application is displayed. The web application component delivers the push message to the web application. The web application displays the push message after receiving the push message. Since the push message has been displayed, the push message is then deleted. If the browser is closed before the push message is deleted, the push message is still stored in the local database of the browser. Thus the browser may display the push message when running the next time.

In an example, the information center may perform registration at the background server by using registration information sent by the web application. When a browser opens a page of a web application, the information center may receive registration information sent by the web application through an interface of the browser which is called using Java script codes, sends the registration information to the background server to have the web application registered at the background server.

In an example, the web application component may perform registration at the information center by using an identity identifying the web application, which is denoted as appid, and a process of the web application component during an initiation process of the web application component. After obtaining a push message for the web application from the background server, the pulling process sends the push message to the information center by using an appid in the push message. After receiving the push message, the information center calls a process of the web application component, e.g., the process that performs the registration previously, by using the appid to process the push message. If there is no process corresponding to the appid, the push message is neglected.

According to examples, there are two types of registration processes. One registration process involves a web application registers at the background server via the information center when the web application is visited (i.e., after the browser opens a page providing the web application); the other registration process involves a web application component registers at the information center when the browser initiates the web application component after startup. The former registration process informs the background server that the browser has executed the web application so that the background server may send push messages for the web application to the browser. The latter registration process informs the information center that the web application component exists in the browser so that the information center may send push messages for the web application to the web application component after obtaining push messages from the background server. In an example, when only the former registration process is carried out, e.g., when the web application component corresponding to the web application has not been set up in the browser, and the web application has performed registration at the background server when the browser opens the page providing the web application, the browser may send a push message obtained from the background server to the web application, and the web application may display the push message on the page. In an example, when only the latter registration process is carried out, e.g., when the web application component corresponding to the web application has been set up in the browser but the browser has not opened a page providing the web application after startup, the web application component performs registration at the information center, and the information center may send a push message corresponding to the web application to the web application component after obtaining the push message for the web application.

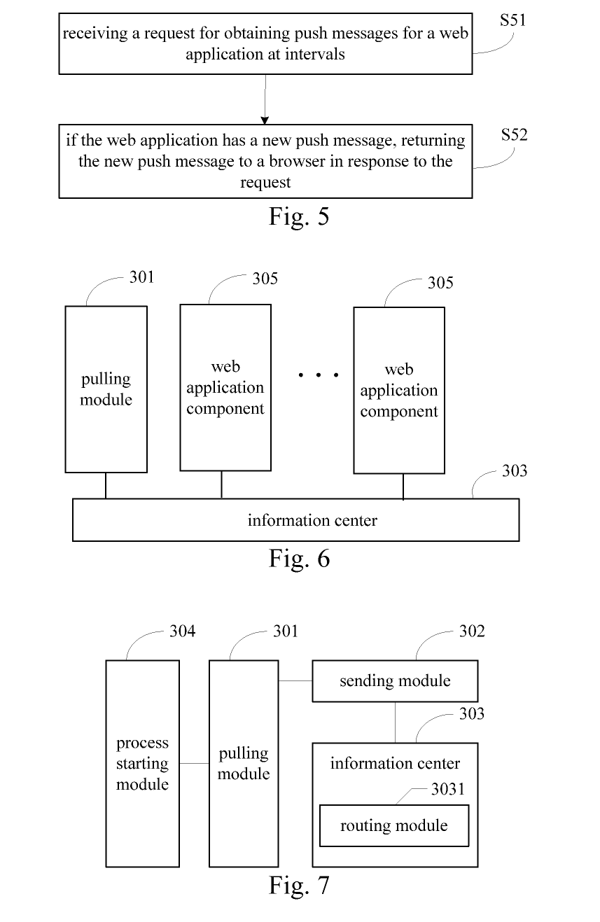

FIG. 5 is a flowchart illustrating a method of pushing messages for web applications in accordance with an example of the present disclosure. The method may include the following procedures.

At block S51, a request for obtaining a push message for a web application is received.

In an example, a pulling process in a browser may set up a timer component. When the timer expires, the pulling process may send a request to the background server. The request is for requesting the background server to provide push messages for web applications that have registered at the background server. The background server may receive the request at intervals.

At block S52, if there is a new push message for the web application, the new push message is returned to the browser in response to the request.

If the web application that has registered at the background server has a new push message, the background server may push the new push message to the pulling process of the browser in response to the request. The pulling process receives the push message returned by the background server. The push message may include an identity identifying the web application.

The process of the example as shown in FIG. 5 may also include a procedure of the background server performing registration by using registration information forwarded by the information center. In an example, after the browser opens a page providing a web application (e.g., visiting the webpage of the web application which is triggered by a user clicking on a display element (e.g., an icon) corresponding to the web application in the user interface of the browser or inputting a web address of the web application), a Java script code segment in the web application may call an interface of the browser to perform registration at the background server. The background server may remember status information of the web application and an identity of the user of the browser. The registration process informs the background server that the browser (which may be identified by an identity of the user of the browser) is visiting the web application (which may be identified by an identity of the web application) and status information of the web application. The status information of the web application refers to information that identifies the user visiting the web application, e.g., a user account for the web application, a QQ ID and the like. The background server may also provide information in the registration information of the web application (e.g., the identity of the browser, the status information of the web application and etc.) for a server of the web application. When detecting that there is a new push message for the web application having the status information, the server of the web application may inform the background server of the browser, and the background server may send the push message to the browser.

As such, the background server may return new push messages for the web application at intervals in response to received requests for push messages corresponding to the web application. Since latest messages for web applications can be presented in the user interface of the browser, messages for web applications can be easily pushed to users of terminal devices according to the technical scheme to implement functions such as update alert and service operations, which can improve user satisfaction and increase user retention.

FIG. 6 is a schematic diagram illustrating modules of an apparatus of pushing messages for web applications in accordance with an example of the present disclosure. The apparatus may be a browser stored in a processor-readable storage medium, and may include the following components.

A pulling module 301 obtains a push message corresponding to a web application from a background server.

A message center 303 provides the push message obtained by the pulling module 301 for a web application component corresponding to the web application.

A web application component 305 presents information of the push message in a user interface of the browser.

FIG. 7 is a schematic diagram illustrating modules of an apparatus of pushing messages for web applications in accordance with an example of the present disclosure. Only those features related with the implementation of the mechanism are illustrated for simplicity. The apparatus as shown in FIG. 7 may be a browser. The apparatus may include a pulling module 301, a sending module 302, an information center 303 and a process starting module 304. The information center 303 may include a routing unit 3031.

The process starting module 304 starts a pulling process of a browser which sends a request at intervals to a background server of the browser for obtaining push messages for a web application registered at the background server.

The pulling module 301 obtains a push message for the web application from the background server. The push message may include an identity identifying the web application.

The sending module 302 sends the push message for the web application to the information center 303.

The routing unit 3031 routes the push message to the web application component identified by the identity in the push message.

The above modules are merely examples of implementations of the mechanism of the present disclosure. It will be appreciated that some or all of the functions of the modules may be implemented by a set of different modules, i.e., the apparatus may have a different structure, according to the needs, such as requirement of hardware of the apparatus or for facilitating development of the software. In various examples, the modules may be implemented by hardware or by software executed by proper hardware. For example, the pulling module may be a hardware module capable of obtaining the push message corresponding to the web application from the background server, e.g., a message pulling device, or be a general-purpose processor or other hardware executing a computer program to implement the functions; the routing module may be a hardware module capable of routing the push message to the web application identified by the identity in the push message, e.g., a message router, or be a general-purpose processor or other hardware executing a computer program to implement the function. This applies to all of the examples.

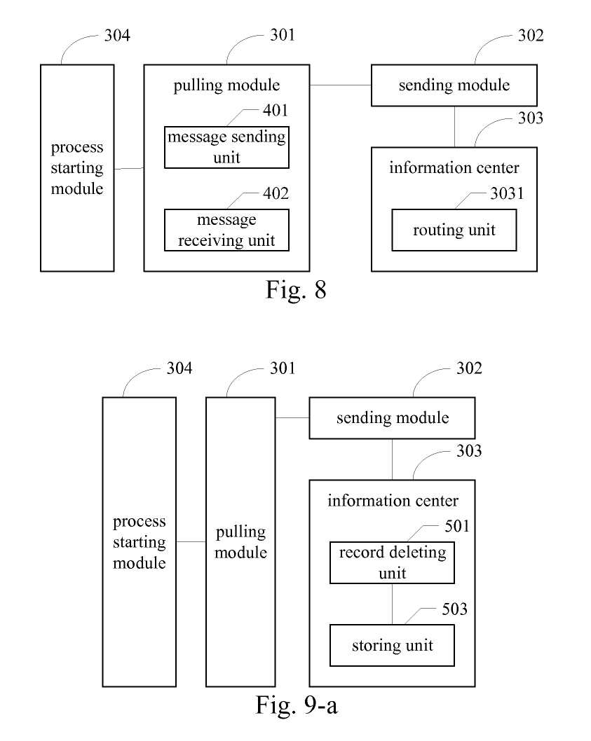

As shown in FIG. 8, the pulling module 301 of FIG. 7 may include a request sending unit 401 and a message receiving unit 402.

The request sending unit 401 may send a request for obtaining a push message corresponding to a web application to the background server when a pre-determined period of time expires.

The message receiving unit 402 receives the push message for the web application returned by the background server in response to the request.

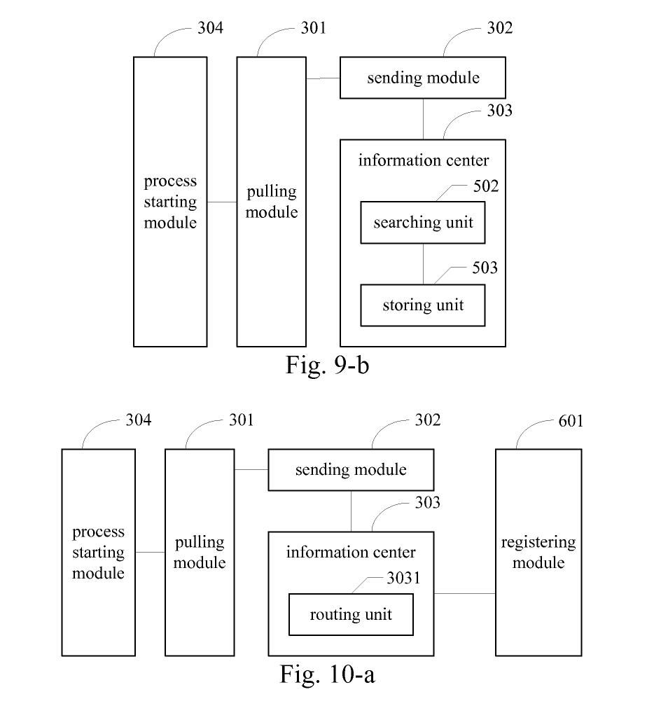

As shown in FIG. 9-a or 9-b, the information center 303 of FIG. 7 may also include a record deleting unit 501 and a storing unit 503 or a searching unit 503.

The storing unit 503 stores the push message for the web application into a local database.

The record deleting unit 501 deletes a record corresponding to a push message for the web application stored in the local data base when the push message is deleted.

The searching unit 502 searches the local database for a push message for the web application after the browser starts up.

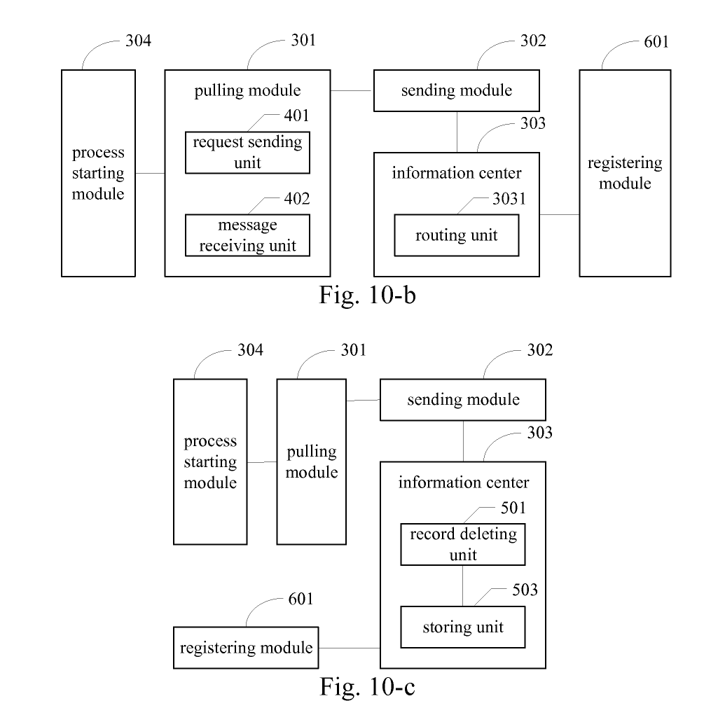

As shown in FIGS. 10a, 10-b, 10-c and 10-d, the apparatus as shown in any of FIGS. 7-9 may also include a registering module 601. The registering module 601 performs registration at the background server by using registration information sent by the web application.

The registering module 601 may include a registration information receiving unit and a registration information sending unit. The registration information receiving unit receives registration information sent by a web application calling an interface of the browser by using Java script codes; and the registration information sending unit sends the registration information to the background server to register the web application at the background server.

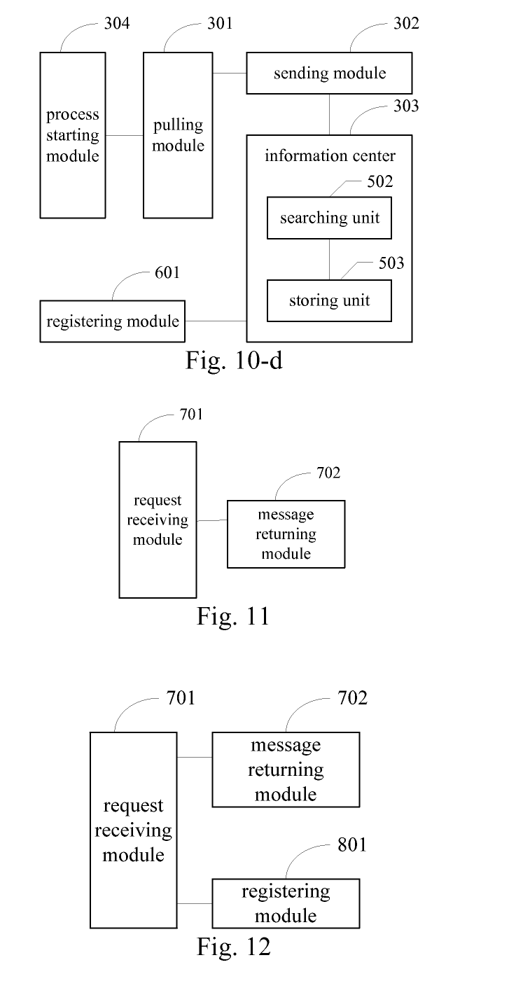

FIG. 11 is a schematic diagram illustrating modules of an apparatus of pushing messages for web applications in accordance with an example of the present disclosure. Only those features related with the implementation of the mechanism are illustrated for simplicity. The apparatus as shown in FIG. 11 may be a background server interacting with a browser. The apparatus may include a request receiving module 701 and a message returning module 702.

The request receiving module 701 receives a request for obtaining a push message corresponding to a web application at intervals.

The message returning module 702 returns a new push message for the web application to a browser in response to the request if the web application has the new push message.

As shown in FIG. 12, the apparatus of FIG. 11 may also include a web application registering module 801. The web application registering module 801 receives registration information forwarded by an information center and has the web application registered.

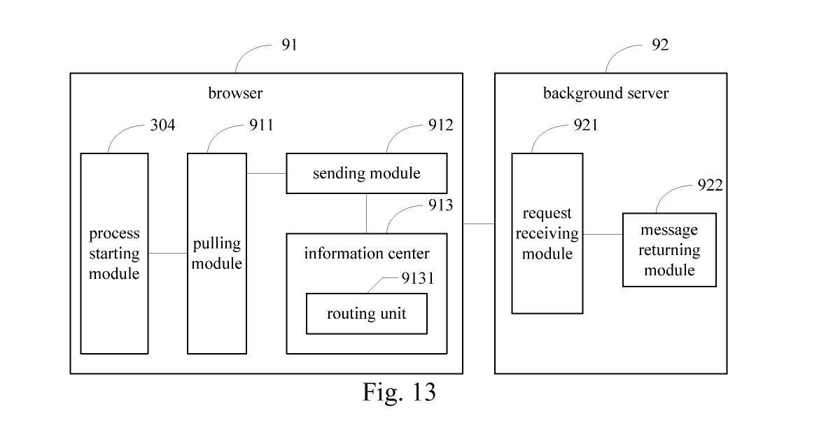

FIG. 13 is a schematic diagram illustrating modules of a system of pushing messages for web applications in accordance with an example of the present disclosure. Only those features related with the implementation of the mechanism are illustrated for simplicity. The system as shown in FIG. 13 may include a browser 91 and a background server 92. The browser 91 may include a pulling module 911, a sending module 912, an information center 913 and a process starting module 914. The information center 913 may include a routing unit 9131. The background server 92 may include a request receiving module 921 and a message returning module 922.

The process starting module 914 starts a pulling process of a browser which sends requests at intervals to the background server of the browser for obtaining push messages for a web application registered at the background server.

The pulling module 911 obtains a push message for the web application from the background server. The push message may include an identity identifying the web application.

The sending module 912 sends the push message for the web application to the information center 913.

The routing unit 9131 routes the push message to the web application component identified by the identity in the push message.

The request receiving module 921 receives a request for obtaining a push message corresponding to a web application at intervals.

The message returning module 922 returns a new push message for the web application to the browser 91 in response to the request if the web application has the new push message.

Various examples are based on a single general concept, thus the information interaction and processings carried out by the modules/units have the same technical merits as the method examples which are not repeated herein.

Some or all of the procedures of the methods provided by various examples, e.g., any of the following sets of procedures, may be carried out by program codes executed by hardware:

A first set of procedures may include: starting a pulling process of a browser, sending a request at intervals to a background server for obtaining a push message corresponding to a web application that has registered at the background server; obtaining a push message for the web application from the background server, the push message including an identity which identifies the web application; sending the push message to an information center; the information center routing the push message to the web application component by using the identity.

A second set of procedures may include: receiving a request for obtaining a push message corresponding to a web application at intervals; if there is a new push message for the web application, returning the new push message to a browser in response to the request.

An example provides a system of pushing messages for web applications. The system may include a browser and a background server. The browser may include:
a message pulling module, adapted to obtain a push message corresponding to a web application from the background server;
a message center, adapted to provide the push message obtained by the message pulling module for a web application component corresponding to the web application; and
the web application component, adapted to present information of the push message in a user interface of the browser.

The background server may include:
a request receiving module, adapted to receive a request for obtaining a push message corresponding to a web application at interval; and
a message returning module, adapted to return a new message corresponding to the web application to a browser in response to the request if there is the new push message for the web application.

According to an example of the present disclosure, a non-transitory computer-readable storage medium may include a set of instructions for pushing messages for web applications. The set of instructions may cause at least one process to perform the acts of:
providing a display element in a user interface of a browser, the display element corresponding to a web application;
obtaining a push message corresponding to the web application from a background server; and
displaying information of the push message via the display element in the user interface of the browser.

It should be understood that in the above processes and structures, not all of the procedures and modules are necessary. Certain procedures or modules may be omitted according to the needs. The order of the procedures is not fixed, and can be adjusted according to the needs. The modules are defined based on function simply for facilitating description. In implementation, a module may be implemented by multiple modules, and functions of multiple modules may be implemented by the same module. The modules may reside in the same device or distribute in different devices. The “first”, “second” in the above descriptions are merely for distinguishing two similar objects, and have no substantial meanings.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

A machine-readable storage medium is also provided, which is to store instructions to cause a machine to execute a method as described herein. Specifically, a system or apparatus having a storage medium which stores machine-readable program codes for implementing functions of any of the above examples and which may make the system or the apparatus (or CPU or MPU) read and execute the program codes stored in the storage medium. In addition, instructions of the program codes may cause an operating system running in a computer to implement part or all of the operations. In addition, the program codes implemented from a storage medium are written in a storage device in an extension board inserted in the computer or in a storage in an extension unit connected to the computer. In this example, a CPU in the extension board or the extension unit executes at least part of the operations according to the instructions based on the program codes to realize the technical scheme of any of the above examples.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

The scope of the claims should not be limited by the embodiments set forth in the examples, but should be given the broadest interpretation consistent with the description as a whole.

1. A method of pushing messages for web applications, comprising:
providing a web application component in a browser, the web application component corresponding to a web application;
obtaining, by the browser, a push message corresponding to the web application from a background server, and providing the push message for the web application component;
presenting, by the web application component, information of the push message in a user interface of the browser.

2. The method of claim 1, wherein the obtaining by the browser a push message corresponding to the web application from a background server and providing the push message for the web application component comprises:
starting a pulling process of a browser which sends a request to a background server of the browser for obtaining at least one push message for a web application that has registered at the background server;
obtaining a push message for the web application from the background server, the push message comprising an identity identifying the web application;
sending the push message for the web application to an information center; and
routing, by the data center, the push message for the web application to the web application component that is identified by the identity in the browser.

3. The method of claim 1, wherein the obtaining by the browser a push message corresponding to the web application from a background server comprises:
sending the request to the background server when a pre-defined period of time expires; and
receiving the push message returned by the background server in response to the request.

4. The method of claim 1, further comprising:
storing, by the browser, the push message for the web application into a local database; and
searching the local database for at least one push message for the web application after the browser starts up.

5. The method of any of claims 1, further comprising:
registering, by the browser, at the background server by using registration information sent by the web application.

6. The method of claim 5, wherein the registering by the browser at the background server by using registration information sent by the web application comprises:
receiving, by the browser, the registration information sent by the web application calling an interface of the browser using Java script codes; and
sending, by the browser, the registration information to the background server to register the web application at the background server.

7. The method of claim 1, further comprising:
receiving, by the background server, the request for obtaining a push message for a web application;
if there is a new push message for the web application, returning the new push message to the browser in response to the request.

8. An apparatus of pushing messages for web applications, comprising a processor and a memory; the memory storing a browser which comprises:
a pulling module, adapted to obtain a push message corresponding to a web application from a background server;
a message center, adapted to provide the push message obtained by the pulling module for a web application component corresponding to the web application;
the web application component, adapted to present information of the push message in a user interface of the browser.

9. The apparatus of claim 8, wherein the browser further comprises:
a process starting module, adapted to start a pulling process of a browser which sends a requests at intervals to the background server of the browser for obtaining at least one push message for the web application that has registered at the background server; and
a sending module, adapted to send the push message obtained by the pulling module to the message center, the push message comprising an identity which identifies the web application;
wherein the information center comprises a routing unit adapted to route the push message to the web application component identified by the identity in the push message.

10. The apparatus of claim 8, wherein the pulling module comprises:
a request sending unit, adapted to send a request for obtaining at least one push message corresponding to the web application to the background server when a pre-determined period of time expires; and
a message receiving unit, adapted to receive the push message for the web application returned in response to the request by the background server.

11. The apparatus of claim 8, wherein the information center further comprises:
a storing unit, adapted to store the push message for the web application into a local database; and
a message searching unit, adapted to search the local database for at least one push message for the web application after the browser starts up.

12. The apparatus of any of claims 8, wherein the information center further comprises:
a registering module, adapted to perform registration at the background server by using registration information sent by the web application.

13. The apparatus of claim 12, wherein the registering module comprises:
a registration information receiving unit, adapted to receive the registration information sent by the web application calling an interface of the browser using Java script codes; and
a registration information sending unit, adapted to send the registration information to the background server to register the web application at the background server.

14. A system of pushing messages for web applications, comprising a browser and a background server; wherein the browser comprises:
a message pulling module, adapted to obtain a push message corresponding to a web application from the background server;
a message center, adapted to provide the push message obtained by the pulling module for a web application component corresponding to the web application;
the web application component, adapted to present information of the push message in a user interface of the browser.

15. The system of claim 14, wherein the background server comprises:
a request receiving module, adapted to receive a request for obtaining a push message corresponding to a web application at interval; and
a message returning module, adapted to return a new message corresponding to the web application to a browser in response to the request if there is the new push message for the web application.
